(19) United States
(12) Patent Application Publication
(10) Pub. No.: US 2026/0057218 A1
(43) Pub. Date: Feb. 26, 2026

(54) DYNAMIC MULTIMODAL PROMPT GENERATION FOR EFFICIENT CONTENT MODERATION

(71) Applicant: Microsoft Corporation, Redmond, WA (US)

(72) Inventors: Akshat MATHUR, Bengaluru (IN); Rishi GUPTA, Bengaluru (IN); Shivansh MUNDRA, Bangalore (IN); Smitkumar Narotambhai MARVANIYA, Bengaluru (IN); Mukesh SINGH, Bengaluru (IN)

(21) Appl. No.: 18/813,563

(22) Filed: Aug. 23, 2024

(51) Int. Cl. G06N 3/0475; G06F 16/23; G06F 16/93; G06N 3/0455

(52) U.S. Cl. CPC G06N 3/0475; G06F 16/2379; G06F 16/93; G06N 3/0455

(57) ABSTRACT

Aspects of the disclosure include methods and systems for content moderation, and specifically dynamic multimodal prompt generation for efficient content moderation. A method includes receiving, by a prompt generation system, a request for a decision corresponding to content. The method includes generating, by an encoder of the prompt generation system, an embedding of the content, and retrieving, by an embedding based retrieval (EBR) module of the prompt generation system, K retrieved chunks from a database, the K retrieved chunks having a Kth closest distance to the embedding in an embedding space. A dynamic prompt comprising a prompt template, multiple retrieved chunks of the K retrieved chunks, and the content is generated and input to a pre-trained large language model. The LLM generates the decision, which is returned responsive to the request.

### INTRODUCTION

The subject disclosure relates to machine learning, online platforms, and content moderation, and specifically to dynamic multimodal prompt generation for efficient content moderation.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram for a content moderation service in accordance with one or more embodiments;

FIG. 2 depicts an example transformer-based architecture in accordance with one or more embodiments;

FIG. 3 depicts an example policy module of the content moderation service of FIG. 1 in accordance with one or more embodiments;

FIG. 4 depicts a block diagram of a computer system according to one or more embodiments; and

FIG. 5 depicts a flowchart of a method in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying figures and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

The rise of Web 2.0 ushered in an era of unprecedented access to user-generated content. Various online platforms now exist which allow users to freely post and exchange content, share their opinions, etc. Content sharing (or simply “sharing”) is one of the most fundamental and constitutive activities of Web 2.0. Online platforms which allow, promote, and/or otherwise enable content sharing are incredibly varied, and include social media platforms that host a wide variety of user-generated content such as text posts, images, videos, and live streams, video sharing platforms that allow users to share user-uploaded video and live streaming content, discussion forums and message boards, blogs, E-commerce platforms that host user-generated content such as product listings, reviews, and buyer/seller communications, dating and relationship apps having user profiles, messages, and images, online gaming platforms with in-game and out-of-game chat and community forums, and review and recommendation sites. While there are numerous types of online platforms that enable content sharing, each of these platforms shares at least one attribute: they each often employ some form of content moderation.

Content moderation refers to the practice of monitoring and applying a set of rules, guidelines, and policies to user-generated content submissions. This process determines whether a particular piece of content should be published, flagged, restricted, modified, and/or removed from a platform. Content moderation typically covers a wide range of issues, including but not limited to the identification of illegal content, hate speech and discrimination, violence and graphic content, harassment and bullying, misinformation and disinformation, copyright infringement, spam, and scams (collectively, “flagged” content). Unfortunately, content moderation itself (that is, the identification and handling of flagged content) is an evolving, challenging problem, and online platforms must navigate a complex ecosystem of legal, ethical, and social considerations when determining what content to allow, restrict, remove, etc.

Current approaches to content moderation are somewhat varied, and include pre-moderation, where content is reviewed before it is published, post-moderation, where content is reviewed after it is published, and reactive moderation, where content is only reviewed after being flagged (either by an automated system, by moderators, and/or by users). Content moderation can be manual, relying on subject matter experts to enforce policy, automated using AI and machine learning to identify problematic content, or can be distributed, relying on the underlying community for moderation, or a combination of these approaches.

Some online platforms can host millions of users and can host hundreds of millions (or more) of pieces of content. As a result, manual human review alone (distributed or via trained reviewers) cannot meet the scaling needs of all platforms. Thus, content moderation systems today are primarily machine learning-based (ML-based) systems. For example, one type of ML-based system is the supervised ML model: these are ML models trained on a human curated training dataset for a particular policy and include positive and negative examples for that policy. They output a score from 0-1 denoting the probability of content being in violation of the respective policy. This approach is somewhat limited. For example, supervised ML models are static in the sense that these models require re-training on policy updates. Re-training on each policy update is computationally expensive and is not always possible (e.g., compute time can be longer than updates between policies). Generative AI based classification, on the other hand, often requires the AI engineers implementing such a system to code (write) policy explanations into a prompt framework for each policy, which is time consuming and inefficient, as AI engineers are not likely to be the correct owners (controllers, etc.) of the policies. In addition, the number of prompts can be hard to maintain due to new guidelines being continuously and/or periodically added (e.g. elections), updated, or deleted. Observe, for example, that each regular update to a policy document will require a change in the associated prompt and/or prompt framework (and this happens every time). Moreover, even a single policy can be different for different geographical regions (e.g. versions of a discriminatory jobs policy for different countries). Another limitation of these conventional systems is that the underlying rationale for a given content moderation decision is unknown. For example, if an LLM gets the reasoning wrong for a particular policy and piece of content, there is no straightforward way to determine which part(s) of the respective policy document caused the issue. In other words, conventional content moderation systems fail at providing interpretability.

This disclosure introduces a dynamic multimodal prompt generation system and framework for efficient content moderation. In some embodiments, a collection of policy documents is segmented into a plurality of so-called policy chunks, which are stored in a policy database. Later, a selection of those policy chunks is combined with content to dynamically generate a content moderation prompt that is unique to the respective policy chunks and content. In some embodiments, the policy chunks are selected (retrieved) according to a multimodal similarity search. In some embodiments, the content and policy chunks are converted into embeddings, and the multimodal similarity search involves finding the policy chunk(s) that are most similar (within a chosen embedding space) to the content. The dynamically generated content moderation prompt can then be passed to a large language model to determine whether the respective content violates the respective policy chunk(s). Content which violates the policy chunk(s) can be deleted, modified, etc., as desired.

The dynamic multimodal prompt generation system described herein offers a range of advantages over conventional AI and ML-based content moderation systems. In particular, the dynamically generated content moderation prompt natively handles any changes made to the underlying policies without requiring any re-training of the large language model. In other words, the dynamic multimodal prompt generation system described herein is completely model agnostic. Observe, for example, that an update to any policy within the policy database will necessarily result in an update to (or addition of) at least one policy chunk, which will necessarily result in a corresponding update to the respective policy chunk embedding(s). This will cause a change to the multimodal similarity search (that is, the “closest” policy chunk embeddings can and will change due to the introduction of updated/new policy chunk embeddings)—in turn causing a change in the dynamically generated content moderation prompt itself. In other words, while the prompt passed to the large language model will dynamically change in response to changes in policy, the actual large language model itself remains the same. This is an enormous savings in compute, as training and re-training large language models is computationally complex, expensive, and time-consuming.

Moreover, dynamic multimodal prompt generation systems described herein naturally solve at least a portion of the interpretability problem mentioned earlier—in short, the underlying policy chunks involved with a particular content moderation decision are known, and thus, erroneous decisions made by the system can be traced to the exact policy chunks involved in such a decision. Policy chunks which are frequently (against any predetermined or desired threshold) involved in erroneous content moderation decisions can be flagged and automatically and/or manually modified. As used herein, an “erroneous” policy decision refers to policy decision that is known to be incorrect (e.g., via known labels, golden examples, and/or manual review via subject matter experts). Similarly, policy chunks which are often involved (again, against any predetermined or desired threshold) in ambiguous policy decisions can be flagged and automatically and/or manually modified. As used herein, an “ambiguous” policy decision refers to policy decisions made by the underlying large language model which have a level of model confidence below a predetermined threshold. For example, consider a scenario where the large language model provides a predictive score where 0 indicates no policy violation and 1 indicates a policy violation. An ambiguous predictive score can be defined as a score between 0.45 and 0.55 (that is, scores for content-policy chunk pairs in which the large language model has the least level of confidence). The thresholds themselves can be modified as desired.

In any case, manual modifications might involve making changes to the policy itself (perhaps the policy was literally ambiguous or otherwise difficult to implement). Automatic modifications, in contrast, might involve re-chunking the underlying policy (e.g., increasing and/or decreasing the scope/context including in one or more policy chunks) and rechecking the content against the modified policy chunks. This automated process can be iteratively repeated to converge towards policy chunks (and policy chunk boundaries) which are the most helpful in making correct content moderation decisions. Thus, the dynamic multimodal prompt generation system described herein streamlines the content moderation process by ensuring that content moderation decisions are more responsive to policy changes and emerging content trends, and improves policy design itself by identifying policy gaps and ambiguities in those policies.

### DETAILED EMBODIMENT

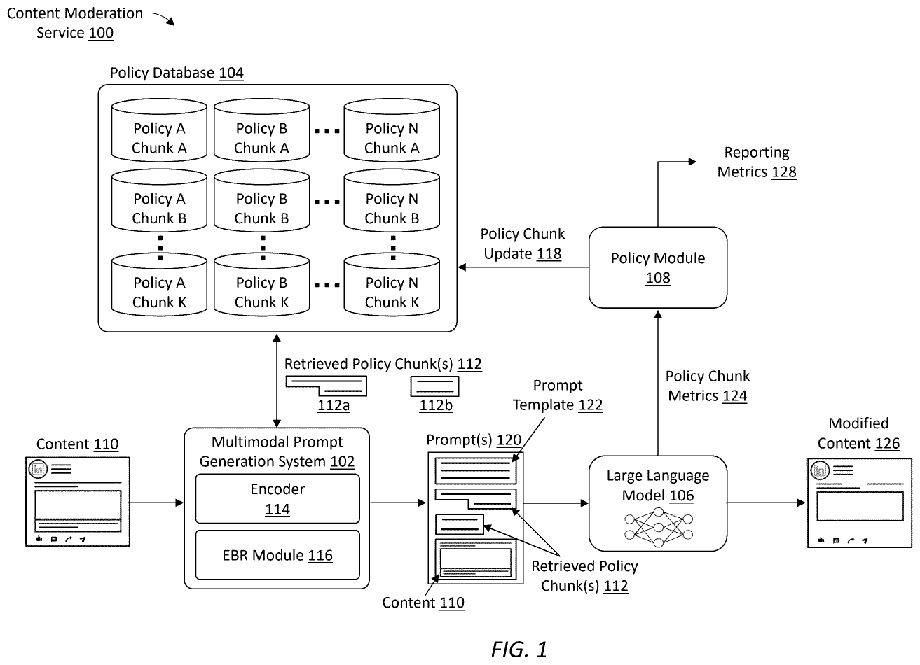

FIG. 1 depicts a block diagram for a content moderation service 100 in accordance with one or more embodiments. As will be described in further detail herein, the content moderation service 100 leverages a multimodal prompt generation system 102 for efficient content moderation. As shown in FIG. 1, the content moderation service 100 includes the multimodal prompt generation system 102, a policy database 104, a large language model 106, and a policy module 108, each configured and arranged as shown. The multimodal prompt generation system 102, policy database 104, large language model 106, and policy module 108 can each be stored and/or implemented on cloud, on one or more client and/or server-side device(s), or on a combination thereof.

As further shown in FIG. 1, content moderation service 100 further includes content 110 that is transmitted to or otherwise received by the multimodal prompt generation system 102. Content 110 is not meant to be particularly limited, but can include text, video, images, and/or any combination of multimodal subject matter for which a content moderation decision is desired, such as, for example, text messages and posts, images, videos, live streams, blogs, adverts, product listings, product reviews, user-to-user (e.g., buyer/seller messages) or user-to-platform (e.g., reaction posts) communications, user profile data, community forum content, etc. In some embodiments, the content 110 includes social media content of a connections network, such as member-to-member messages, job postings, news and news reactions, event announcements and invitations, etc.

In some embodiments, the multimodal prompt generation system 102 receives content 110 and, in response, fetches one or more policy chunks (e.g., retrieved policy chunks 112) from the policy database 104. The retrieved policy chunks 112 themselves are discussed in greater detail below. In some embodiments, the multimodal prompt generation system 102 includes an encoder 114 (e.g., a large language model encoder) that generates embeddings for the content 110, and these embeddings are leveraged to fetch the policy chunks.

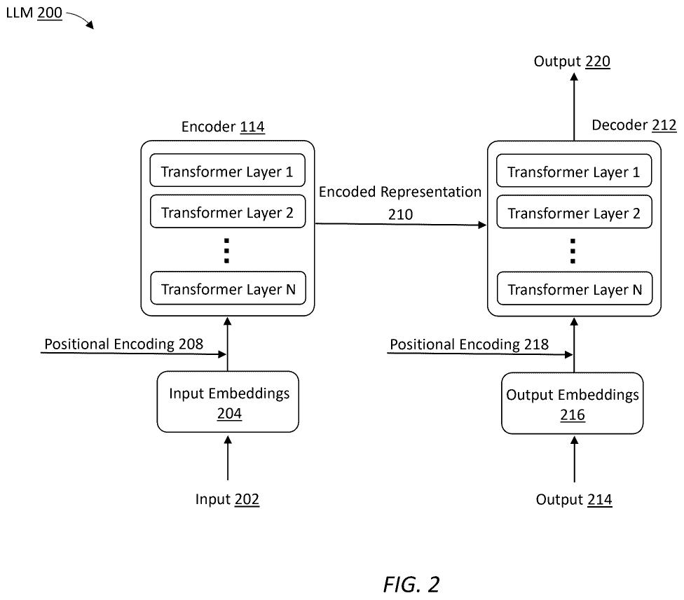

In some embodiments, encoder 114 is an encoder of a pre-trained large language model 200 (LLM 200, refer to FIG. 2). In some embodiments, the LLM 200 and encoder 114 are trained to generate and understand embeddings and embedding spaces. More specifically, in some embodiments, the LLM 200 and/or encoder 114 are trained specifically to generate embeddings and/or for the task of mapping content 110 to their corresponding embedding and/or embedding space.

While not meant to be particularly limited, the LLM 200 and/or encoder 114 can include a neural network machine learning architecture that is capable of processing large amounts of text data and generating high-quality natural language responses. In practice, large language models have been used for a wide range of natural language processing (NLP) tasks, including, for example, machine translation, text generation, sentiment analysis, and question answering (i.e., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers. RNNs are neural networks that process sequences of inputs one by one, and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

Large language models are typically trained on large amounts of text data, often containing hundreds of millions if not billions of words. To handle the large amount of data, the training process is often highly parallelized. The training process can take several days or even weeks, depending on the size of the model and the amount of training data involved. Large language models can be trained using backpropagation and gradient descent, with the objective of minimizing a loss function such as cross-entropy loss.

FIG. 2 illustrates an example transformer-based architecture for LLM 200 in accordance with one or more embodiments. As shown in FIG. 2, the transformer-based architecture begins with an input 202. The input 202 denotes an input provided by a user (or upstream system) and can be represented as a sequence of tokens, individual words or sub-words, from which input embeddings 204 can be generated. The input embeddings 204 represent the tokens within the input 202 as numbers, which can be processed using an encoder 206 (e.g., the encoder 114 of FIG. 1). In some embodiments, a positional encoding 208 can be generated to encode the position of each token in input 202 as a set of numbers. These numbers can be fed into the encoder 206 with the input embeddings 204, allowing the transformer-based architecture for LLM 200 to more effectively understand the order of words in a sentence and to thereby generate grammatically correct and semantically meaningful outputs.

The encoder 206 processes the input embeddings 204 and the positional encoding 208 and generates, for the input 202, an encoded representation 210 that captures the meaning and context of the input 202. To accomplish this, encoder 206 applies a series of self-attention transformer layers (or simply, “transformer layers”), which are a series of hidden states that represent the input 202 at different levels of abstraction. The encoder 206 can include any number of these transformer layers, as desired. The encoded representation 210 is provided to a decoder 212.

The decoder 212 similarly includes a number of transformer layers, as desired, except that the decoder 212 processes an output 214. In most implementations, the output 214 is a right-shifted copy of the input 202, meaning that the decoder 212 can only use the previous words for next-word prediction. In some embodiments, output embeddings 216 can be generated from the output 214 to represent the tokens in the output 214 as numbers, in a similar manner as described with respect to the encoder 206. A positional encoding 218 can be added to the output embeddings 216 to encode the position of each token in output 214 as a set of numbers. The decoder 212 can be trained by minimizing a loss function (also known as an objective function, which quantifies a difference between a predicted output and a known true value) using, for example, gradient descent.

Once trained, the transformer-based architecture 200 can be used during an inference phase to generate an output 220, which can be thought of as a next-word probability (that is, how likely is the next word in the sequence to be x, or y, etc.). In some configurations, the transformer-based architecture 200 includes a linear layer and SoftMax layer (omitted for clarity) to transform a raw output from the decoder 212 into the output 214. For example, after the decoder 212 produces a raw output (e.g., output embeddings), the linear layer can map the output embeddings to a higher-dimensional space, thereby transforming the output embeddings into a same original input space as the input 202. The SoftMax function can be used to generate a probability distribution for each output token in the vocabulary, enabling the transformer-based architecture 200 to generate output tokens with probabilities (e.g., the output 220).

Returning now to FIG. 1, in some embodiments, encoder 114 is trained to generate an embedding for the content 110. In some embodiments, the embedding for content 110 is passed to an Embedding Based Retrieval (EBR) module 116. In some embodiments, EBR module 116 is a Retrieval-Augmented Generation (RAG)-based multimodal matching module (also referred to herein as a multimodal similarity search module) that returns the K policy chunks (e.g., the retrieved policy chunks 112) that are semantically the Kth closest to the embedding of the content 110 in the respective embedding space according to a predetermined distance measure (e.g., Euclidean distance, cosine similarity, dot product, etc.). K itself is not meant to be particularly limited and can be chosen as desired. In some embodiments, K can be dynamically determined based, for example, on a maximum and/or minimum distance threshold.

In some embodiments, the EBR module 116 can be configured for rule-based exclusions, thereby allowing the EBR module 116 to handle unique and/or specific scenarios such as geographical carve outs. For example, if the content 110 is posted from country Z, Policy T does not apply, and a rule-based exclusion can be enforced such that the EBR module 116 will not include policy chunks from Policy T in the retrieved policy chunks 112 (e.g., if country Z, then ignore policy T).

To service multimodal content (that is, to enable multimodal similarity search), the EBR module 116 is trained to embed text and image data into the same embedding space (e.g., the same vector space) using, for example, Contrastive Language-Image Pretraining (CLIP). In some embodiments, such as when content 110 contains both image and text components, EBR module 116 can complete similarity searches for the components separately, or together, as desired. In some embodiments, such as when content 110 contains video inputs, EBR module 116 can be trained via CLIP to break down videos into key frames and to create from those key frames a collage. This collage then can be used as an image in a similar manner as per native images. In other words, EBR module 116 can match an embedding of the collage to one or more policy chunks. Alternatively, or in addition, in some embodiments, EBR module 116 can match each key frame (via its respective embedding) with its own policy chunks.

Turning now specifically to the policy database 104, in some embodiments, policy database 104 includes one or more policies (as shown, Policy A, Policy B, . . . , Policy N). The number of policies and the policies themselves are not meant to be particularly limited. Companies, advertisers, connections networks, and individuals, etc., can employ a range of policies for content moderation, tailored to their specific platform, user base, and legal requirements. These policies are often interconnected and may overlap in certain areas. Policies are often reviewed and updated regularly to address emerging issues and changing social norms. The specific content, scope, and enforcement provisions of these policies can vary significantly between platforms, often reflecting their unique user bases, content types, and values. For illustrative purposes only, policies might include community guidelines, platform terms of service (TOS), hate speech and discrimination policies, violence and graphic content policies (including, e.g., exceptions for newsworthy or educational content), harassment and bullying policies, misinformation and disinformation policies, copyright and intellectual property policies (e.g., DMCA compliance measures), impersonation policies (including, e.g., special provisions for parody or fan accounts), spam and manipulation policies, privacy and personal information policies, terrorist and extremist content policies (including, e.g., law enforcement cooperation policies), platform-specific content policies (e.g., livestreaming policies), and contextual exception policies (e.g., guidelines for allowing otherwise prohibited content in specific contexts such as for educational content).

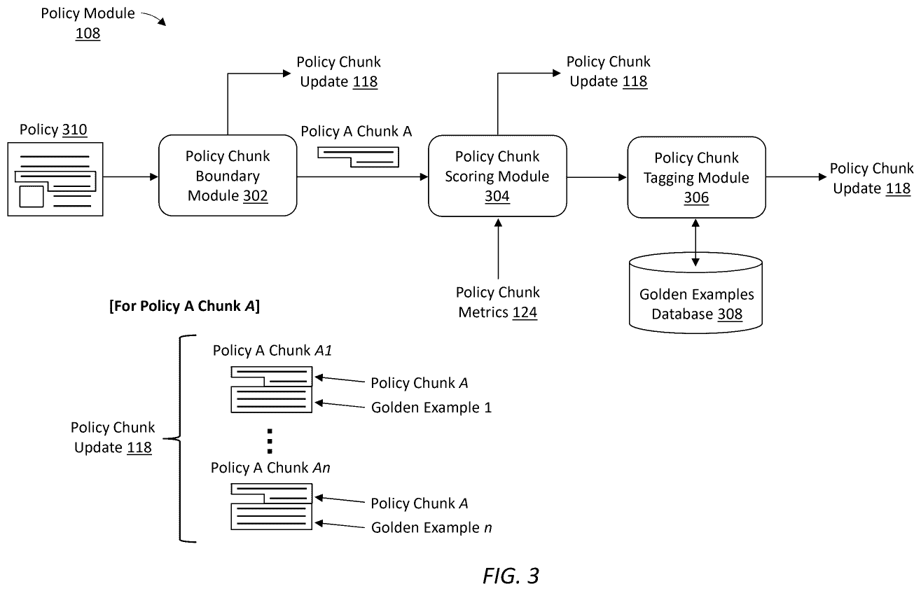

In some embodiments, each of the policies (e.g., Policy A, Policy B, . . . , Policy N) is segmented into a plurality of policy chunks. For example, Policy A might be segmented into Chunk A, Chunk B, . . . , Chunk K (as shown). The number of chunks for a given policy is not meant to be particularly limited, and the total number of chunks for each policy need not be the same. The generation of policy chunks (referred to herein as a policy chunk update 118) is discussed in greater detail with respect to FIG. 3.

In some embodiments, the policies and associated policy chunks in the policy database 104 are continuously and/or periodically updated, for example, in response to a change in any of the underlying polices. In some embodiments, policy database 104 can be updated manually, for example, via removing, adding, or modifying one or more policies and/or policy chunks. In some embodiments, policy database 104 updates automatically in response to a policy change to any policy within the policy database 104 and/or in response to the addition and/or deletion of a policy in the policy database 104. Changes to any policy document can be determined by automatically monitoring the associated documents for any content that is removed, added, or modified, as desired (via, e.g., versioning control), allowing the policy database 104 to automatically monitor and adapt to changes in policy. In this manner, policy database 104 can serve as an accurate, up-to-date policy repository.

Returning to the multimodal prompt generation system 102, in some embodiments, the multimodal prompt generation system 102 dynamically builds a multimodal prompt 120 from the output of the EBR module 116. In some embodiments, the prompt 120 includes the retrieved policy chunk 112, the content 110, and a prompt template 122.

In some embodiments, prompt template 122 contains content moderation instructions for the large language model 106, such as instructions on moderating content based on any attached or referenced policy documents. For example, prompt template 122 might include instructions to the large language model 106 to consider content 110 in the context of the retrieved policy chunks 112 and to determine whether the content 110 violates any portion(s) of the retrieved policy chunks 112. The prompt template 122 can include instructions to the large language model 106 to provide an analysis (referred to herein as “Policy Chunk Metrics 124”) identifying any of the retrieved policy chunks 112 which are violated by the content 110 and/or providing a mapping between the retrieved policy chunks 112 and the portions of the content 110 which triggered the policy violation. In some embodiments, the prompt template 122 is a common element across all prompts 120 (that is, the prompt template 122 is shared across prompts 120). In some embodiments, the prompt template 122 is agnostic to the policy wordings of any particular policy in policy database 104.

In contrast to the prompt template 122, the retrieved policy chunks 112 (including, as shown, a first chunk 112a and a second chunk 112b) and the content 110 are not common to all prompts 120. Observe, for example, that the content 110 being evaluated for content moderation decisions changes over time, and such changes will necessarily result in changes to the retrieved policy chunks 112 due to differences in the underlying embeddings. For example, a first piece of content including a job posting for role A at company B having associated responsibilities C and skill requirements D will have a different embedding than a second piece of content involving the sale of item X having features Y and Z. Such differences in embeddings will result in different distances to the embeddings of the various policy chunks in the policy database 104. Consequently, the retrieved policy chunks 112 vary dynamically with the content 110. As a result, each of the prompts 120 encodes a unique combination of multimodal content and policy. Thus, the multimodal prompt generation system 102 can be thought of as a dynamic multimodal prompt generator.

In some embodiments, the prompt 120 is passed to large language model 106. The large language model 106 can be the same model as, or a different model than, the pre-trained LLM 200 (refer to FIG. 2) discussed with respect to encoder 114. In some embodiments, large language model 106 is a multimodal LLM such as, for example, GPT-4-Vision. Notably, in some embodiments, large language model 106 is pre-trained to classify content 110 and/or to review and apply one or more polices to content 110 (e.g., to determine whether some content violates a policy). Advantageously, large language model 106 does not require training on the policies themselves, or re-training on policy updates (e.g., changes to any policy in policy database 104). Instead, as discussed previously, updates to any policy within the policy database 104 will necessarily result in an update to (or addition of) at least one policy chunk, which will necessarily result in a corresponding update to the respective policy chunk embedding(s). This will cause a change to the multimodal similarity search of the EBR module 116 (that is, the “closest” policy chunk embeddings can and will change due to the introduction of updated/new policy chunk embeddings)—in turn causing a change in the selection of the retrieved policy chunks 112 and, ultimately, the dynamically generated prompt 120. In other words, the prompt 120 passed to the large language model 106 will dynamically change in response to changes in policy, allowing the large language model 106 to remain the same (stated yet again for emphasis, the handling of changes in policy is shifted from the LLM to the dynamic prompt in the present architecture). This is a marked improvement over current LLM and supervised ML-based models, as prior approaches require additional compute for re-training on policy updates.

In some embodiments, large language model 106 generates policy chunk metrics 124 in response to receiving the prompt 120. While not meant to be particularly limited, policy chunk metrics 124 can include an analysis identifying any of the retrieved policy chunks 112 which are violated by the content 110 and/or providing a mapping between the retrieved policy chunks 112 and the portions of the content 110 which triggered the policy violation. Policy chunk metrics 124 can include a listing of all violated policy chunks and/or the respective portion(s) of the content 110 which caused such policy violations. In this manner, policy chunks which are frequently violated (against any predetermined threshold) can be identified.

Policy chunk metrics 124 can include a confidence metric and/or prediction score (also referred to herein as an ambiguity metric) for each of the violated policy chunks and/or their respective portion(s) of the content 110 which caused such policy violations. For example, consider a scenario where the large language model 106 is trained to provide a predictive score, where a score of 0 indicates complete confidence in no policy violation and a score of 1 indicates complete confidence in a policy violation for a particular content 110—retrieved policy chunk 112 pair. In some embodiments, scores above a predetermined threshold (e.g., above 0.51, above 0.6, above 0.9, etc.) indicate partial confidence of various degrees in a policy violation and scores below a predetermined threshold (e.g., below 0.49, below 0.4, below 0.25, etc.) indicate partial confidence of various degrees in no policy violation being present. In this manner, retrieved policy chunks 112 which are frequently associated with (against any predetermined threshold) ambiguous predictive scores can be identified (recall that ambiguous predictive scores can refer to scores within some threshold distance from 0.5, such as 0.45 to 0.55—that is, scores having a level of confidence that is below some predetermined threshold).

Policy chunk metrics 124 are passed to policy module 108. In some embodiments, the policy module 108 generates a policy chunk update 118 and/or reporting metrics 128 responsive to the policy chunk metrics 124. The policy chunk update 118 can be stored in the policy database 104. For example, the policy module 108 can modify or delete an existing policy chunk in policy database 104 and/or can add a new policy chunk to the policy database 104 responsive to the policy chunk metrics 124. For example, a retrieved policy chunk 112 which is frequently associated with (again, against any predetermined threshold) ambiguous predictive scores can be re-chunked to increase or decrease the scope (e.g., amount of text, number of video/audio tokens, etc.) of the respective retrieved policy chunk 112. In another example, a retrieved policy chunk 112 which is frequently associated with ambiguous predictive scores can be modified to include one or more so-called golden examples (also referred to as labels). In some embodiments, golden examples include portions of content which are known to violate (or known not to violate) the respective retrieved policy chunk 112 (negative labels and positive labels, respectively). In some embodiments, golden examples include portions of content which were previously associated with ambiguous predictive scores in addition to their known labels. In this manner, the policy module 108 can continuously improve the quality of the policy chunks in the policy database 104.

Observe that modifying a retrieved policy chunk 112 to increase or decrease the scope of the respective policy chunk, and/or to incorporate one or more golden examples, will result in a change to that policy chunk's respective embedding and a corresponding change in the embedding distances to embeddings of the content 110. Consequently, modifying a retrieved policy chunk 112 will result in a change in how that respective chunk is fetched in response to content 110. In this manner, the retrieved policy chunks 112 fetched by the multimodal prompt generation system 102 will, over time, iteratively converge towards policy chunks (or modified policy chunks) that do not result in ambiguous predictive scores.

In some embodiments, reporting metrics 128 can include a description and/or listing of the policy chunk update 118. In some embodiments, reporting metrics 128 can include the associated content 110 which triggered the policy chunk update 118. In this manner, the rationale behind the policy chunk update 118 can be reviewed, manually or automatically, by external system(s), processes, and/or subject matter experts (e.g., policy experts and/or controllers). Reporting metrics 128 need not be so limited, and can also include continuous or periodic measurement metrics such as tracking precision, recall, decision metrics, appeal rates, false positives and false negatives at the policy chunk level to help in interpreting content moderation decisions and for aiding in discovering the potential gaps in policy and enforcement documents. Reporting metrics 128 can include the generation of alerts (to any desired downstream party and/or system) as well as reports, aiding in the timely modifications or update of policy guidelines.

Advantageously, the reporting metrics 128 can be leveraged to quickly determine which types of content 110 are more likely (or less likely) to trigger a policy chunk update 118 and/or modified content 126 (discussed below). Similarly, the reporting metrics 128 can be leveraged to quickly determine which portions of policy (that is, which of the retrieved policy chunks 112) are causing ambiguous policy decisions. In some embodiments, the reporting metrics 128 are used as evidence to make changes directly to the underlying policy. For example, portions of policy which have been found to cause ambiguous policy decisions can be rewritten automatically or manually (e.g., via a subject matter expert) to clarify the context and/or scope of the associated portion of the policy.

In some embodiments, large language model 106 generates modified content 126 from the content 110 in response to receiving the prompt 120 and/or generating the policy chunk metrics 124. In some embodiments, the modified content 126 is a new and/or modified version of the content 110 that does not include the portion(s) which triggered a policy violation of one or more of the retrieved policy chunks 112. In some embodiments, the modified content 126 is passed to external system(s) (not separately indicated) for publication. In some embodiments, the external system(s) can be the same system(s) from which the original content 110 was provided. In some embodiments, the content moderation service 100 is integrated with and/or otherwise incorporated within or alongside the external system(s). For example, the external system(s) can include publishing services and/or social media platforms for posting content 110, such as a connections network. In this manner, the content moderation service 100 can serve as an external and/or internal check for provisional content prior to live publication in the service or platform.

FIG. 3 depicts an example policy module 108 of the content moderation service 100 of FIG. 1 in accordance with one or more embodiments. In some embodiments, policy module 108 can include a policy chunk boundary module 302, a policy chunk scoring module 304, a policy chunk tagging module 306, and a golden examples database 308, configured and arranged as shown.

In some embodiments, the policy chunk boundary module 302 receives a policy (here, policy A). In some embodiments, policy A is retrieved from a policy database (e.g., the policy database 104 of FIG. 1). In some embodiments, the policy chunk boundary module 302 generates, in response to receiving policy A, one or more policy chunks (e.g., policy A chunk A . . . policy A chunk K). Different approaches to chunking an input text and/or multimodal content are possible, such as fixed size chunking, heuristic chunking, and semantic chunking, and all such configurations and combinations thereof are within the contemplated scope of this disclosure.

For example, in some embodiments, policy chunk boundary module 302 utilizes fixed size chunking. In this configuration, the policy chunk boundary module 302 chunks an incoming document according to a predetermined chunking interval (that is, a predetermined number of words or tokens for each chunk segment). In some embodiments, fixed size chunking can include setting an overlap parameter so that context is not lost between chunks. In some embodiments, the overlap parameter defines a maximum number of words or tokens which can overlap between adjacent chunks, and fixed size chunking can vary between chunks (subject to the overlap limit) to preserve context. In some embodiments, finding optimal values for parameters such as the number of tokens in a chunk, overlap values, and/or a maximum token limit, etc., are found iteratively by initializing those values as desired and then adjusting those values in view of empirical performance data. In any case, context preservation can be estimated using heuristics and/or semantic analysis, as explained below (e.g., extend a chunk by a few tokens to reach end of sentence, extend a chunk by a few tokens to avoid cutting out material of high semantic similarity, etc.). In some embodiments, non-text media can be considered a separate chunk for fixed sized chunking. In some embodiments, text summaries can be generated for non-text media and those text summaries can be chunked.

In another example, policy chunk boundary module 302 utilizes heuristic chunking. In this configuration, the policy chunk boundary module 302 considers each paragraph (or line, etc.) as a chunk. If a paragraph is very large (e.g., exceeds a predetermined threshold length), a chunk can be split based on a predetermined maximum token length parameter (as per fixed size chunking defined above). If the paragraph is smaller than a predetermined minimum token length parameter, the policy chunk boundary module 302 can append dummy tokens (also referred to as unknown tokens or UNK tokens) to reach the minimum length requirement. Non-text media can be considered as a chunk and summaries can be considered as separate paragraphs (or lines, etc.) in a similar manner as discussed with respect to fixed size chunking. In some embodiments, a section heading can be appended as a prefix in the paragraph chunk itself to give context about the paragraph.

In yet another example, the policy chunk boundary module 302 includes and/or is incorporated with an encoder (e.g., encoder 114 of FIG. 1) and/or a large language model (e.g., the large language model 106 of FIG. 1) for generating and understanding embeddings, and the policy chunk boundary module 302 generates the one or more policy chunks via semantic chunking. In contrast to fixed size chunking or heuristic chunking, the policy chunk boundary module 302 can adaptively pick breakpoints in-between sentences using embedding similarities. In some embodiments, semantic chunking involves generating the embeddings of every subcomponent (e.g., sentence, paragraph, token string, etc.) in the respective policy, comparing the similarity of all embedded subcomponents with each other, and then grouping subcomponents with the most similar embeddings (according to any desired distance measure and threshold). This approach ensures that each chunk contains sentences that are semantically related to each other.

In some embodiments, policy chunk boundary module 302 estimates and/or otherwise measures chunk performance. In some embodiments, each chunk can be assigned a fitness metric (or simply “fitness”). In some embodiments, the fitness metric will first be calculated based on an offline dataset and then will be regularly monitored in an online setting. In some embodiments, fitness (or “goodness”) is determined according to the following equation:

$$goodness ( {chunk}_{i} ) = \frac{number of samples where {chunk}_{i} was involved in correct decisions}{total number of samples where {chunk}_{i} was involved}$$

In some embodiments, a minimum threshold can be set for the total number of involvements to avoid considering chunks as problematic which are not yet sufficiently used to generate enough data for consideration.

In some embodiments, policy chunk boundary module 302 iterates on chunks based on downstream empirical performance, thus gradually improving the chunking process. In some embodiments, policy chunk boundary module 302 can identify so-called “bad” or problematic chunks. In some embodiments, policy chunk boundary module 302 can iterate through the chunking process (learning chunking parameters, etc.) using an offline dataset. In some embodiments, the offline dataset includes a true label attached to each sample. After running offline, policy chunk boundary module 302 will reach a moderation decision on each sample and the performance can be scored according to the known true labels (that is, a decision is correct if it matches the true label of the respective sample). Moreover, fitness can be determined as described previously for each chunk based on all decisions using the formula above. In that scenario, chunks having less than a predetermined fitness value and more than a predetermined number of total involvement can be treated as problematic chunks. Intuitively, these are chunks which have enough involvement for meaningful analysis, but which are present in too many (again, according to any predetermined threshold) incorrect moderation decisions.

A somewhat similar procedure can be used to find problematic chunks online. To illustrate, consider an online setting such as a connections network where feed posts and feed comments are moderated in real-time and/or near real-time. The policy chunk boundary module 302 can run in this online fashion for a predetermined fixed period of time (e.g., a week, a day, a month, etc.), and a collection of moderation decisions on each sample can be generated for all eligible content. Observe that, unlike the offline setting, the online setting does not have access to a true label against each sample. Thus, in some embodiments, a pseudo label can be generated using user/member feedback. For example, a label for an example moderation decision can be set as “false” if the sample was allowed by the system but flagged by a predetermined threshold number of users/members of the underlying network. Intuitively, if a threshold number of users/members of a connections network disagrees with a moderation decision, that information itself can be used as a pseudo label for the respective sample. The feedback criteria can evolve iteratively as previous discussed, thereby becoming more complex based on the use case. Fitness can be determined as described previously for each chunk based on all decisions calculated in the prior step (the online servicing of any predetermined number of moderation decisions). Chunks having less than a predetermined fitness value and more than a predetermined number of total involvement can be treated as problematic chunks in a similar manner as described with respect to the offline setting.

In some embodiments, policy chunk boundary module 302 can iteratively modify problematic chunks to improve fitness. In some embodiments, chunk modification can be automatic, as described according to any of the following scenarios. For example, problematic chunks can be modified by merging the problematic chunk with the chunk above it (the chunk preceding it). Problematic chunks can be modified by merging the problematic chunk with the chunk below it (the chunk following it). Problematic chunks can be modified by splitting the problematic chunk into K parts according to any of the previously mentioned chunking techniques (e.g., fixed size chunking, heuristic chunking, semantic chunking). Problematic chunks can be removal altogether (note that in this scenario only the policy chunk is deleted, the associated policy document is not altered).

In some embodiments, policy chunk boundary module 302 can select a modification scheme according to learned empiric performance data. For example, the policy chunk boundary module 302 can perform an offline evaluation on a golden dataset (e.g., a known high quality dataset). This evaluation is feasible since the size of the golden dataset can be limited as desired. The policy chunk boundary module 302 can then determine which chunk modification method provided the highest percentage improvement in fitness and/or any other metric of interest. In some embodiments, policy chunk boundary module 302 stops the evaluation if performance is degraded beyond a predetermined limit and reverts to collecting more data in an online setting.

The resulting policy chunk(s) (e.g., policy A chunk A) can be passed as a policy chunk update 118 to policy database 104 (refer to FIG. 1). Additionally, or alternatively, in some embodiments, the resulting policy chunk(s) are passed to a policy chunk scoring module 304. In some embodiments, policy chunk metrics 124 (refer to FIG. 1) are also passed to the policy chunk scoring module 304.

In some embodiments, the policy chunk boundary module 302 and the policy chuck scoring module 304 work cooperatively to identify (overlapping) boundaries of policy chunks using both static and dynamic constraints. As used herein, a “static constraint” includes the detection of topic changes, syntactic boundaries, and/or semantic boundaries in the respective policy and can be applied via semantic chunking, topic detection, syntactic parsing, and similar techniques. As used herein, a “dynamic constraint” includes identifying policy gaps in the respective policy, such as via an ambiguity metric as discussed previously, and increasing or decreasing the boundaries around the respective policy chunk to improve the ambiguity metric. For example, application of a dynamic constraint can include identifying a particular policy chunk (e.g., policy A chunk A) as having a predictive score of 0.47 and modifying (increasing or decreasing) the distance measure threshold used for selecting the most similar component embeddings, thereby generating a new policy chunk having wider (or narrower) boundaries. The resulting policy chunk can be re-scored against content 110 and this process can be iterated by the policy chunk scoring module 304 as desired to achieve any desired level of confidence in the predictive scores (that is, until the new value of the predictive score for a given policy chunk is above or below any desired predetermined threshold). The resulting policy chunk(s) (e.g., policy A chunk A) can be passed as a policy chunk update 118 to policy database 104 (refer to FIG. 1).

In some embodiments, one or more of the policy chunk(s) (e.g., policy A chunk A) are passed to a policy chunk tagging module 306. As discussed previously, the boundary of a policy chunk can be iteratively changed to improve the respective ambiguity metric. Additionally, or alternatively, in some embodiments, the resulting policy chunk(s) can be tagged with golden examples to improve (or further improve) the respective ambiguity metric. In some embodiments, the policy chunk tagging module 306 is coupled to, or incorporated with, golden examples database 308. In some embodiments, the golden examples include multimodal content. In some embodiments, the golden examples include both positive and negative golden examples. As discussed previously, golden examples include portions of content which are known to violate (or known not to violate) the respective retrieved policy chunk 112 (negative golden examples and positive golden examples, respectively). For example, a policy chunk “policy A chunk A” (refer to FIG. 3) might include tags for “policy A chunk A1”, which includes policy chunk A and a first golden example (e.g., “golden example 1”) and “policy A chunk An”, which includes policy chunk A and a second golden example (e.g., “golden example 2”). The first golden example can include an example piece of content which is known to violate policy A and the second golden example can include an example piece of content which is known to not violate policy A. In some embodiments, golden examples are selected to specifically include portions of content which were previously associated with ambiguous predictive scores (that is, golden examples can be “close” cases, according to any desired predetermined threshold).

In some embodiments, policy chunk tagging module 306 is trained to fetch one or more golden examples from the golden examples database 308 and to attach the fetched golden examples to the respective policy chucks, thereby building new policy chunks having additional context for making more accurate content moderation decisions. In some embodiments, policy chunk tagging module 306 includes and/or is incorporated with an encoder (e.g., encoder 114 of FIG. 1) and/or a large language model (e.g., the large language model 106 of FIG. 1) for generating and understanding embeddings, and the policy chunk tagging module 306 is trained to fetch the K closest golden examples (according to any desired distance metric) to the respective policy chunk. In this manner, the policy chunk tagging module 306 serves as a system trained to auto-enrich policy chunks with a collection of multimodal golden positive and negative examples, thereby enhancing the accuracy of policy chunk representations.

In some embodiments, a new, separate policy chunk is generated for each of the retrieved golden examples (that is, for each policy chunk-golden example combination). For example, the K closest golden examples to policy A chunk A might include golden example 1, golden example 2, . . . , golden example n. In that case, n new policy chunks can be generated encoding policy A chunk A1, policy A chunk A2, . . . , policy A chunk An. The resulting policy chunk(s) (e.g., policy A chunk A1 . . . policy A chunk An) can be passed as a policy chunk update 118 to policy database 104 (refer to FIG. 1).

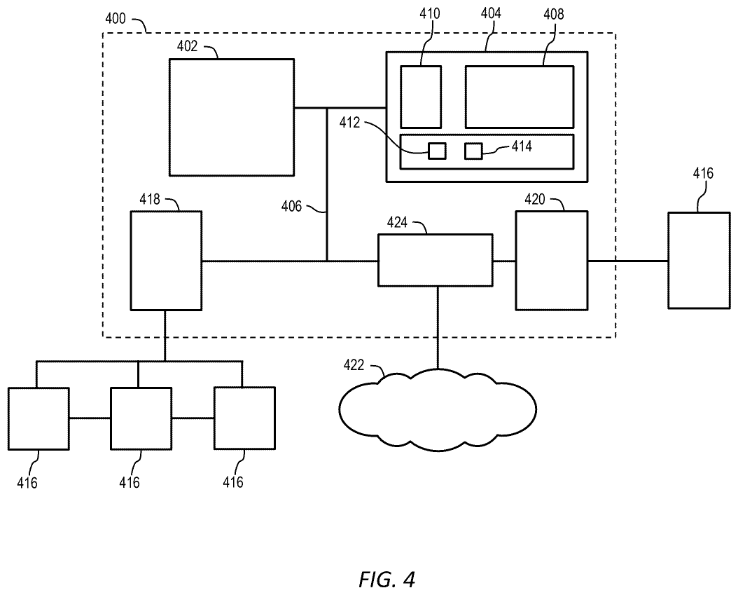

FIG. 4 illustrates aspects of an embodiment of a computer system 400 that can perform various aspects of embodiments described herein. In some embodiments, the computer system(s) 400 can implement and/or otherwise be incorporated within or in combination with the content moderation service 100 (refer to FIG. 1), LLM 200 (refer to FIG. 2), and/or the policy module 108 (refer to FIG. 3). In some embodiments, a computer system 400 can be implemented server-side. For example, a remote computer system 400 can be configured to receive content 110 and/or policy 310, and in response, to generate modified content 126, policy chunk metrics 124, reporting metrics 128, policy chunk updates 118, etc.

The computer system 400 includes at least one processing device 402, which generally includes one or more processors or processing units for performing a variety of functions, such as, for example, completing any portion of the content moderation service 100 described previously. Components of the computer system 400 also include a system memory 404, and a bus 406 that couples various system components including the system memory 404 to the processing device 402. The system memory 404 may include a variety of computer system readable media. Such media can be any available media that is accessible by the processing device 402, and includes both volatile and non-volatile media, and removable and non-removable media. For example, the system memory 404 includes a non-volatile memory 408 such as a hard drive, and may also include a volatile memory 410, such as random access memory (RAM) and/or cache memory. The computer system 400 can further include other removable/non-removable, volatile/non-volatile computer system storage media.

The system memory 404 can include at least one program product having a set (e.g., at least one) of program modules that are configured to carry out functions of the embodiments described herein. For example, the system memory 404 stores various program modules that generally carry out the functions and/or methodologies of embodiments described herein. A module or modules 412, 414 may be included to perform functions related to any of the block diagrams described herein. The computer system 400 is not so limited, as other modules may be included depending on the desired functionality of the computer system 400. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 402 can also be configured to communicate with one or more external devices 416 such as, for example, a keyboard, a pointing device, and/or any devices (e.g., a network card, a modem, etc.) that enable the processing device 402 to communicate with one or more other computing devices. Communication with various devices can occur via Input/Output (I/O) interfaces 418 and 420.

The processing device 402 may also communicate with one or more networks 422 such as a local area network (LAN), a general wide area network (WAN), a bus network and/or a public network (e.g., the Internet) via a network adapter 424. In some embodiments, the network adapter 424 is or includes an optical network adaptor for communication over an optical network. It should be understood that although not shown, other hardware and/or software components may be used in conjunction with the computer system 400. Examples include, but are not limited to, microcode, device drivers, redundant processing units, external disk drive arrays, RAID systems, and data archival storage systems, etc.

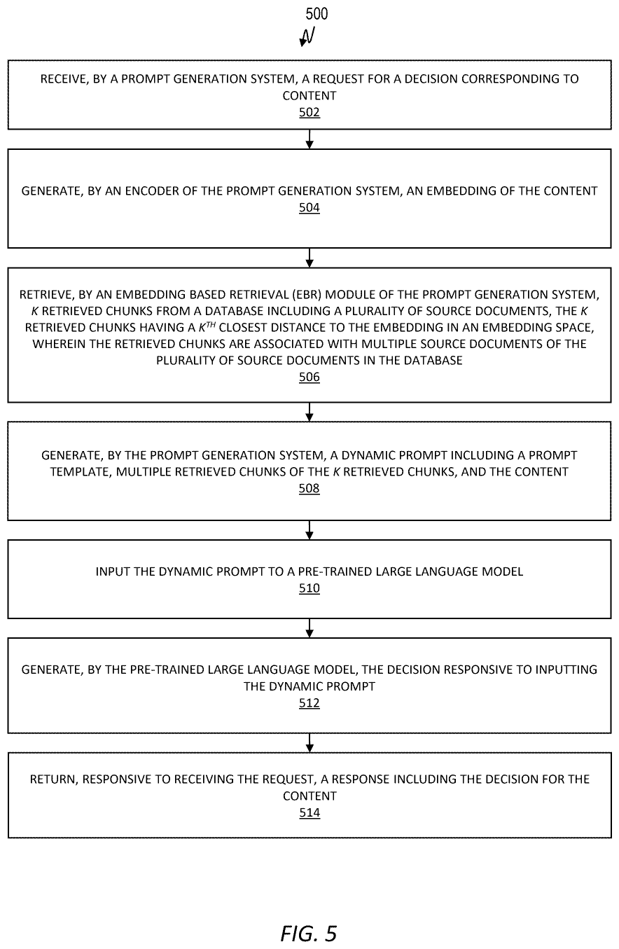

Referring now to FIG. 5, a flowchart 500 for dynamic multimodal prompt generation and efficient content moderation is generally shown according to an embodiment. The flowchart 500 is described with reference to FIGS. 1 to 4 and may include additional steps not depicted in FIG. 5. Although depicted in a particular order, the blocks depicted in FIG. 5 can be, in some embodiments, rearranged, subdivided, and/or combined.

At block 502, the method includes receiving, by a multimodal prompt generation system, a request for a decision (e.g., a content moderation decision) for content.

At block 504, the method includes generating, by an encoder of the multimodal prompt generation system, an embedding of the content.

At block 506, the method includes retrieving, by an embedding based retrieval (EBR) module of the prompt generation system, K retrieved chunks (e.g., policy chunks) from a database (e.g., a policy database) having a plurality of source documents (e.g., policies), the K retrieved chunks having a Kth closest distance to the embedding in an embedding space. In some embodiments, the retrieved chunks are associated with multiple source documents (e.g., multiple separate policies) of the plurality of source documents in the database.

At block 508, the method includes generating, by the multimodal prompt generation system, a dynamic prompt comprising a prompt template, a retrieved chunk of the K retrieved chunks, and the content. In some embodiments, the prompt template is agnostic to any particular policy, and includes generic instructions on moderating content based on attached documents. For example, a prompt template might include the instructions, “Please review the following [retrieved policy chunks 112] and determine whether [content 110] violates one or more of the [retrieved policy chunks 112]. In some embodiments, the prompt template can include instructions to the large language model 106 to provide Policy Chunk Metrics 124 identifying any of the retrieved policy chunks 112 which are violated by the content 110 and/or providing a mapping between the retrieved policy chunks 112 and the portions of the content 110 which triggered the policy violation.

At block 510, the method includes inputting the dynamic prompt to a pre-trained large language model.

At block 512, the method includes generating, by the pre-trained large language model, the decision responsive to inputting the dynamic prompt. In some embodiments, the pre-trained large language model is trained on large amounts of text data, for example, training data containing hundreds of millions or even billions of words. In some embodiments, training the pre-trained large language model includes training the model for next word prediction and involves initializing a plurality of weights in the model and iteratively changing those weights until an accuracy of a next word prediction of the model is greater than a predetermined threshold. In this manner, the pre-trained large language model learns to interpret human language, and textual instructions, such as an instruction to classify content 110 and/or to review and apply one or more polices to content 110 (e.g., to determine whether some content violates a policy).

At block 514, the method includes returning, responsive to receiving the request, a response including the decision for the content.

In some embodiments, the method further includes generating, by the pre-trained large language model, chunk metrics (e.g., policy chunk metrics). In some embodiments, the chunk metrics include a mapping between each of the multiple retrieved chunks and a portion of the content against which each respective retrieved chunk triggered a violation (e.g., a policy violation).

In some embodiments, the method further includes generating, by the pre-trained large language model, modified content. In some embodiments, the modified content includes a version of the content that does not include the portion of the content against which the retrieved policy chunk triggered the violation.

In some embodiments, the method includes receiving an update corresponding to at least one policy of the multiple policies, and modifying, responsive to receiving the update, at least one chunk in the database. For example, the update can include adding, modifying, and/or removing one or more policy documents corresponding to the chunks in the database and the modifying can include adding, modifying, re-chunking, and/or removing the at least one chunk.

In some embodiments, the method further includes generating, by the pre-trained large language model, policy chunk metrics. In some embodiments, the policy chunk metrics include an ambiguity metric for the retrieved policy chunk and a portion of the content.

In some embodiments, the method includes determining that the ambiguity metric corresponding to a respective retrieved chunk is greater than a predetermined threshold, and responsive to the determining, re-chunking the respective retrieved chuck with a different number of tokens.

In some embodiments, the method further includes generating, by a policy module, a chunk update. In some embodiments, the chunk update includes at least one of a boundary update to a retrieved chunk or a modification to a retrieved chunk to include a golden example alongside the respective retrieved chunk. In some embodiments, the golden example includes additional content having a known label with respect to the respective retrieved policy chunk.

In some embodiments, the prompt template is a static prompt template that is common to all prompts created by the multimodal prompt generation system.

In some embodiments, the policy database includes a plurality of policies. In some embodiments, each policy of the plurality of policies includes one or more policy chunks.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer to produce a machine, such that the instructions, which execute via the processor of the special purpose computer, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method comprising:
receiving, by a prompt generation system, a request for a decision corresponding to content;
generating, by an encoder of the prompt generation system, an embedding of the content;
retrieving, by an embedding based retrieval (EBR) module of the prompt generation system, K retrieved chunks from a database comprising a plurality of source documents, the K retrieved chunks having a Kth closest distance to the embedding in an embedding space, wherein the retrieved chunks are associated with multiple source documents of the plurality of source documents in the database;
generating, by the prompt generation system, a dynamic prompt comprising a prompt template, multiple retrieved chunks of the K retrieved chunks, and the content;
inputting the dynamic prompt to a pre-trained large language model;
generating, by the pre-trained large language model, the decision responsive to inputting the dynamic prompt; and
returning, responsive to receiving the request, a response comprising the decision for the content.

2. The method of claim 1, further comprising generating, by the pre-trained large language model, chunk metrics comprising a mapping between each of the multiple retrieved chunks and a portion of the content against which each respective retrieved chunk triggered a violation.

3. The method of claim 1, further comprising:
receiving an update corresponding to at least one policy of the multiple source documents; and
modifying, responsive to receiving the update, at least one chunk in the database.

4. The method of claim 1, further comprising generating, by the pre-trained large language model, chunk metrics comprising, for each retrieved chunk of the multiple retrieved chunks, an ambiguity metric for the respective retrieved chunk and a portion of the content.

5. The method of claim 4, further comprising generating, by a policy module, a chunk update comprising at least one of a boundary update to a retrieved chunk or a modification to a retrieved chunk to include a golden example alongside the respective retrieved chunk, the golden example comprising additional content having a known label with respect to the respective retrieved chunk.

6. The method of claim 1, wherein the prompt template comprises a static prompt template that is common to each source document of the plurality of source documents.

7. The method of claim 4, further comprising:
determining that the ambiguity metric corresponding to a respective retrieved chunk is greater than a predetermined threshold; and
responsive to the determining, re-chunking the respective retrieved chuck with a different number of tokens.

8. A system comprising a memory, computer readable instructions, and one or more processors for executing the computer readable instructions, the computer readable instructions controlling the one or more processors to perform operations comprising:
receiving, by a prompt generation system, a request for a decision corresponding to content;
generating, by an encoder of the prompt generation system, an embedding of the content;
retrieving, by an embedding based retrieval (EBR) module of the prompt generation system, K retrieved chunks from a database comprising a plurality of source documents, the K retrieved chunks having a Kth closest distance to the embedding in an embedding space, wherein the retrieved chunks are associated with multiple source documents;
generating, by the prompt generation system, a dynamic prompt comprising a prompt template, a retrieved chunk of the K retrieved chunks, and the content;
inputting the dynamic prompt to a pre-trained large language model;
generating, by the pre-trained large language model, the decision responsive to inputting the dynamic prompt; and
returning, responsive to receiving the request, a response comprising the decision for the content.

9. The system of claim 8, the operations further comprising generating, by the pre-trained large language model, chunk metrics comprising a mapping between each of the multiple retrieved chunks and a portion of the content against which each respective retrieved chunk triggered a violation.

10. The system of claim 9, the operations further comprising:
receiving an update corresponding to at least one source document of the multiple source documents; and
modifying, responsive to receiving the update, at least one chunk in the database.

11. The system of claim 8, the operations further comprising generating, by the pre-trained large language model, chunk metrics comprising, for each retrieved chunk of the multiple retrieved chunks, an ambiguity metric for the respective retrieved chunk and a portion of the content.

12. The system of claim 11, the operations further comprising generating, by a policy module, a chunk update comprising at least one of a boundary update to a retrieved chunk or a modification to a retrieved chunk to include a golden example alongside the respective retrieved chunk, the golden example comprising additional content having a known label with respect to the respective retrieved chunk.

13. The system of claim 8, wherein the prompt template comprises a static prompt template that is common to each source document of the plurality of source documents.

14. The system of claim 8, the operations further comprising:
determining that the ambiguity metric corresponding to a respective retrieved chunk is greater than a predetermined threshold; and
responsive to the determining, re-chunking the respective retrieved chuck with a different number of tokens.

15. A computer program product comprising a computer readable storage medium having program instructions embodied therewith, the program instructions executable by one or more processors to cause the one or more processors to perform operations comprising:
receiving, by a prompt generation system, a request for a decision corresponding to content;
generating, by an encoder of the prompt generation system, an embedding of the content;
retrieving, by an embedding based retrieval (EBR) module of the prompt generation system, K retrieved chunks from a database comprising a plurality of source documents, the K retrieved chunks having a Kth closest distance to the embedding in an embedding space, wherein the retrieved chunks are associated with multiple source documents;
generating, by the prompt generation system, a dynamic prompt comprising a prompt template, a retrieved chunk of the K retrieved chunks, and the content;
inputting the dynamic prompt to a pre-trained large language model;
generating, by the pre-trained large language model, the decision responsive to inputting the dynamic prompt; and
returning, responsive to receiving the request, a response comprising the decision for the content.

16. The computer program product of claim 15, the operations further comprising generating, by the pre-trained large language model, chunk metrics comprising a mapping between each of the multiple retrieved chunks and a portion of the content against which each respective retrieved chunk triggered a violation.

17. The computer program product of claim 16, the operations further comprising:
receiving an update corresponding to at least one source document of the multiple source documents; and
modifying, responsive to receiving the update, at least one chunk in the database.

18. The computer program product of claim 15, the operations further comprising generating, by the pre-trained large language model, chunk metrics comprising, for each retrieved chunk of the multiple retrieved chunks, an ambiguity metric for the respective retrieved chunk and a portion of the content.

19. The computer program product of claim 18, the operations further comprising generating, by a policy module, a chunk update comprising at least one of a boundary update to the retrieved chunk or a modification to the retrieved chunk to include a golden example alongside the retrieved chunk, the golden example comprising additional content having a known label with respect to the retrieved chunk.

20. The computer program product of claim 15, wherein the prompt template comprises a static prompt template that is common to each source document of the plurality of source documents.
